(19) United States
(12) Patent Application Publication
(10) Pub. No.: US 2007/0127338 A1
(43) Pub. Date: Jun. 7, 2007

(54) Optical disk device

(75) Inventor: Koji Fujita, Osaka (JP)

Correspondence Address: PILLSBURY WINTHROP SHAW PITTMAN, LLP, P.O. BOX 10500, MCLEAN, VA, 22102, US

(73) Assignee: FUNAI ELECTRIC CO., LTD., Osaka (JP)

(21) Appl. No.: 11/605,264

(22) Filed: Nov. 29, 2006

(30) Foreign Application Priority Data
Dec. 1, 2005 (JP) 2005-348167

(51) Int. Cl. G11B 7/00

(52) U.S. Cl. 369/53.31; 369/53.2

(57) ABSTRACT

An optical disk device includes a rewriting and reading means, which includes a pickup head which irradiates laser light upon a rewritable type optical disk, and which rewrites data to or reads data from the rewritable type optical disk. Furthermore, this optical disk device includes a control means which controls rewriting and reading of data by the rewriting and reading means, and which moreover, when a command is issued to rewrite data upon the rewritable type optical disk, acquires, via the rewriting and reading means, from a region upon the rewritable type optical disk which is determined in advance, deterioration information which specifies the extent of progression of the deterioration of the rewritable type optical disk. Furthermore, this optical disk device includes a display means which displays the extent of progression of the deterioration, based upon the deterioration information which has been acquired by the control means.

### CROSS REFERENCE

This Nonprovisional application claims priority under 35 U.S.C. §119(a) on Patent Application No. 2005-348167 filed in Japan on Dec. 1, 2005, the entire contents of which are hereby incorporated by reference.

### BACKGROUND OF THE INVENTION

The present invention relates to an optical disk device which performs reading of data which is recorded upon an optical disk such as a DVD (Digital Versatile Disk) or a CD or the like and recording of data thereupon, and in particular relates to an optical disk device which performs reading of data which is recorded upon a rewritable type optical disk such as a DVD-RW or a CD-RW or the like, and recording of data thereupon.

In the past, optical disk devices which record and replay video and audio upon optical disks have been implemented in practice, and are now generally widespread.

In terms of classification by physical format, these optical disks may be divided into replay only type optical disks, addition type optical disks, and rewritable type optical disks. A replay only type optical disk is, for example, a CD-ROM or a DVD-ROM. Such a replay only type optical disk is an optical disk which can only be replayed, and upon which writing of data cannot be performed. Next, an addition type optical disk is, for example, a CD-R, a DVD-R, or a DVD+R. Such an addition type optical disk is one to which writing of data can be performed once only. Finally, a rewritable type optical disk is, for example, a CD-RW, a DVD-RW, a DVD+RW, or a DVD-RAM. Such a rewritable type optical disk is an optical disk to which writing of data can be performed as many times as desired.

An addition type optical disk is also sometimes termed a write once type disk, and data is recorded upon such a disk by decomposing an organic pigment in a recording layer thereof with laser light of a recording power, thus changing the reflectivity of the disk for laser light. On the other hand, in a rewritable type optical disk, a phase change metallic material is employed for the recording layer of the disk, and data is recorded by irradiating the disk with laser light of a recording power, thus causing a phase change of the crystal state of this material to an amorphous state. And data is deleted by causing, with laser power of a deletion power, a phase change of this amorphous state back to the crystalline state.

Due to this, with a prior art optical disk device which is capable of handling rewritable type optical disks, the user has been able to repeat the actions of recording data upon a rewritable type optical disk, and thereafter rewriting the data, as many times as desired. Here, rewriting of the data principally means overwriting the data, but also includes deleting the data.

On the other hand, an optical disk device such as the one described in Japanese Laid-Open Patent Publication 2000-149256 has been proposed.

However, the number of times that data can be rewritten is also limited with a rewritable type optical disk as well. For example, the maximum number of times that a CD-RW, a DVD-RW, or a DVD+RW can be rewritten is about 1,000. Furthermore, the maximum number of times that a DVD-RAM can be rewritten is about 10,000. The reasons for this are due to the characteristics of the recording layer, such as deterioration of the recording layer (i.e. its limited life) and the like.

Due to this, when this limit upon the number of times that a rewritable type optical disk may be rewritten is exceeded, the number of errors when recording data upon the rewritable type optical disk abruptly increases, and the phenomenon occurs that suddenly recording becomes impossible, without any previous notice. Naturally, even if the user looks at the recording surface of a rewritable type optical disk, he is not able to ascertain the number of times it has been rewritten.

Accordingly, there has been the problem that the user has not been able to ascertain any timing or the like for exchanging the rewritable optical disk. Thus, with a prior art optical disk device, there has been the problem that the rewritable type optical disk suddenly becomes unusable.

Furthermore, if a rewritable type optical disk is initialized (which is undesirable), it appears just like a new product. Accordingly, there has been the problem that the user has not been able to tell whether a rewritable type optical disk is one which can no longer be used, or is a new one.

Furthermore, with an optical disk device such as the one described in Japanese Laid-Open Patent Publication 2000-149256, an error is displayed when a limiting value is exceeded. However, subject to this condition, still it is not possible for the user to distinguish whether the rewritable type optical disk is one for which the number of times it can be rewritten has been exhausted, or is a new one. Due to this, the same problem occurs as described above with reference to the prior art.

Accordingly, the objective of the present invention is to provide an optical disk device which is so built that, by displaying the degree to which the deterioration of a rewritable type optical disk has progressed, it is possible for the user to ascertain a timing for exchanging the rewritable type optical disk or the like.

### SUMMARY OF THE INVENTION

The optical disk device according to the present invention includes a rewriting and reading means, including a pickup head which irradiates laser light upon a rewritable type optical disk, which rewrites data to or reads data from the rewritable type optical disk. With this structure, the rewritable type optical disk is, for example, a CD-RW, a DVD-RW, a DVD+RW, or a DVD-RAM. Furthermore, rewriting of the data primarily means overwrite recording of the data, but also includes deleting the data.

Furthermore, this optical disk device includes a control means which controls rewriting and reading of data by the rewriting and reading means, and which moreover, when a command is issued to rewrite data upon the rewritable type optical disk, acquires, via the rewriting and reading means, from a region upon the rewritable type optical disk which is determined in advance, deterioration information which specifies the extent of progression of deterioration of the rewritable type optical disk. With this structure, the region which is determined in advance may be, for example, a lead-in region.

And this optical disk device includes a display means which displays the extent of progression of the deterioration, based upon the deterioration information which has been acquired by the control means.

With this structure, in the case of a CD-RW, a DVD-RW, or a DVD+RW, the display upon the display means may be, for example, “Now, the number of times this disk has been rewritten is 950” or “Now, the remaining number of times rewriting can be performed is 50”.

### BRIEF DESCRIPTION OF THE DRAWINGS

FIG. 1 is a block diagram showing the main structure of an optical disk device which is an embodiment of the present invention;

FIG. 2 is a figure showing a recorded region upon an optical disk 100;

FIGS. 3A-3C are conceptual figures showing a series of situations in which all of the data which is recorded upon the optical disk 100 is rewritten;

FIGS. 4A-4C are conceptual figures showing a series of situations in which a portion of the data which is recorded upon the optical disk 100 is rewritten; and

FIG. 5 is a flow chart showing the operation performed by a control unit when a rewrite key upon this optical disk device which is an embodiment of the present invention is depressed.

### DETAILED DESCRIPTION OF THE INVENTION

In the following, an optical disk device which is an embodiment of the present invention will be explained.

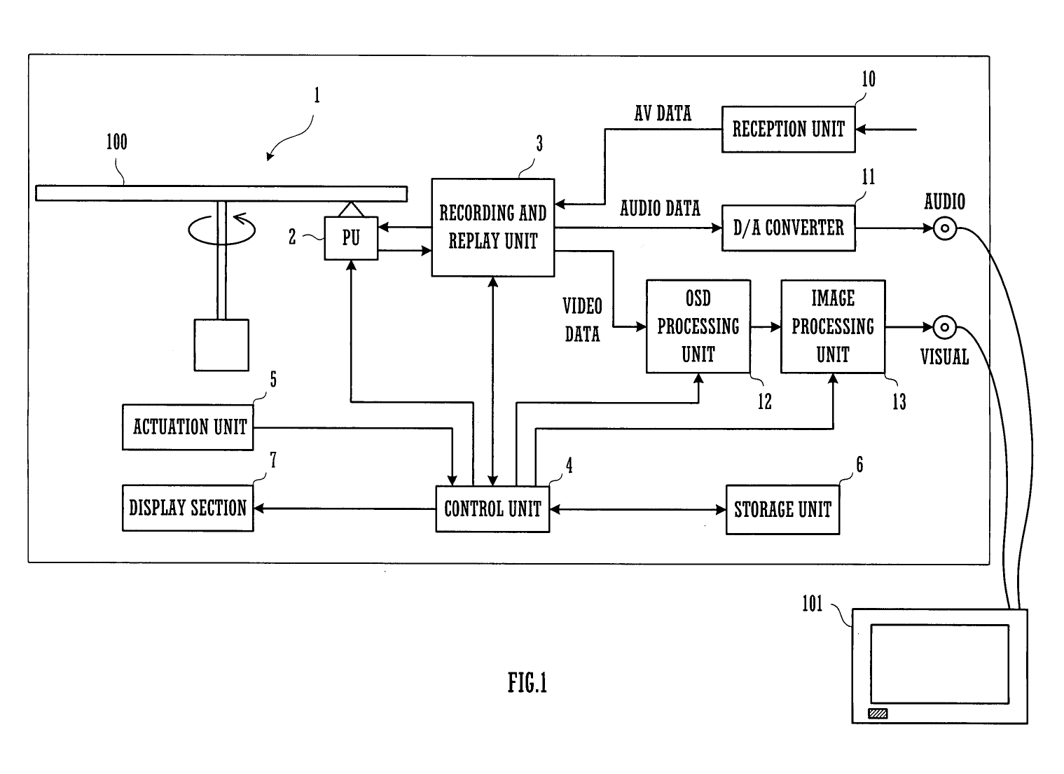

FIG. 1 is a block diagram showing the main structure of an optical disk device which is an embodiment of the present invention. This optical disk device 1 comprises a control unit 4 which controls the operation of the various portions of the optical disk device 1, a pickup head 2 (hereinafter termed the PU head 2) which performs recording of data to an optical disk 100 and deletion of data thereupon and reading of data therefrom, a recording and replay unit 3 such as an RF amp or the like, an actuation unit 5 which receives actuation by the user, a display section 7 which displays information, a storage unit 6 which stores data, a D/A converter 11 which converts audio data into an analog replay audio signal, an image processing unit 13 which converts video data into an analog replay video signal, an OSD processing unit 12 which creates a synthetic image in which an OSD (On Screen Display) image is superimposed upon an image based upon a video signal which has been decoded, and a reception unit 10 which receives a TV broadcast signal and acquires AV (audio-visual) data.

The optical disk device 1 is a so called DVD recorder. Furthermore, the optical disk 100 is a rewritable type optical disk. This optical disk 100 may be, for example, a CD-RW, a DVD-RW, a DVD+RW, or a DVD-RAM. Here, the maximum limit number of times that a CD-RW, a DVD-RW, or a DVD+RW can be rewritten is about 1,000 times. And the maximum limit number of times that a DVD-RAM can be rewritten is about 10,000 times.

The PU head 2 comprises a laser diode (LD), a collimator lens, a beam splitter, an objective lens, a photodetector, a thread motor, and an actuator, none of which are shown in the figures.

The PU head 2 is fitted so as to be able to shift freely along an axis which extends in the radial direction of the optical disk 100. And the thread motor shifts the PU head 2 along this radial direction of the optical disk 100.

The LD is a light source which outputs laser light. The photodetector is made up of a plurality of light receiving elements, and detects light reflected from the optical disk 100.

First, the operation during reading will be explained.

The PU head 2 irradiates laser light of reading power upon the optical disk 100, and detects light reflected back from the optical disk 100 with the photodetector. By doing this, the information recorded upon the optical disk 100 is read out optically.

The recording and replay unit 3 creates an RF signal based upon the output of the plurality of light receiving elements in the PU head 2, and amplifies this RF signal. And the recording and replay unit 3 processes this RF signal and extracts the data therefrom. Here, the video and audio data and so on which is extracted is encoded, for example, by MPEG. And the recording and replay unit 3 decodes this video and audio data and so on. Finally, the recording and replay unit 3 outputs the audio data to the D/A converter 11, and outputs the video data to the OSD processing unit 12, while keeping these data streams mutually synchronized.

The D/A converter 11 converts the audio data which has been expanded to an analog replay audio signal, and outputs this replay audio signal to an external television 101.

Based upon control signals transmitted from the control unit 4, the OSD processing unit 12 changes over its operation between three cases: the case in which the video data is to be passed straight through and directly outputted; the case in which a synthetic image is created by superimposing an OSD image upon an image based upon the video data and this synthetic video data is to be outputted; and the case in which only OSD video data for the OSD image is to be outputted. As for the case in which only OSD video data for the OSD image is to be outputted, this operation is not performed during replay.

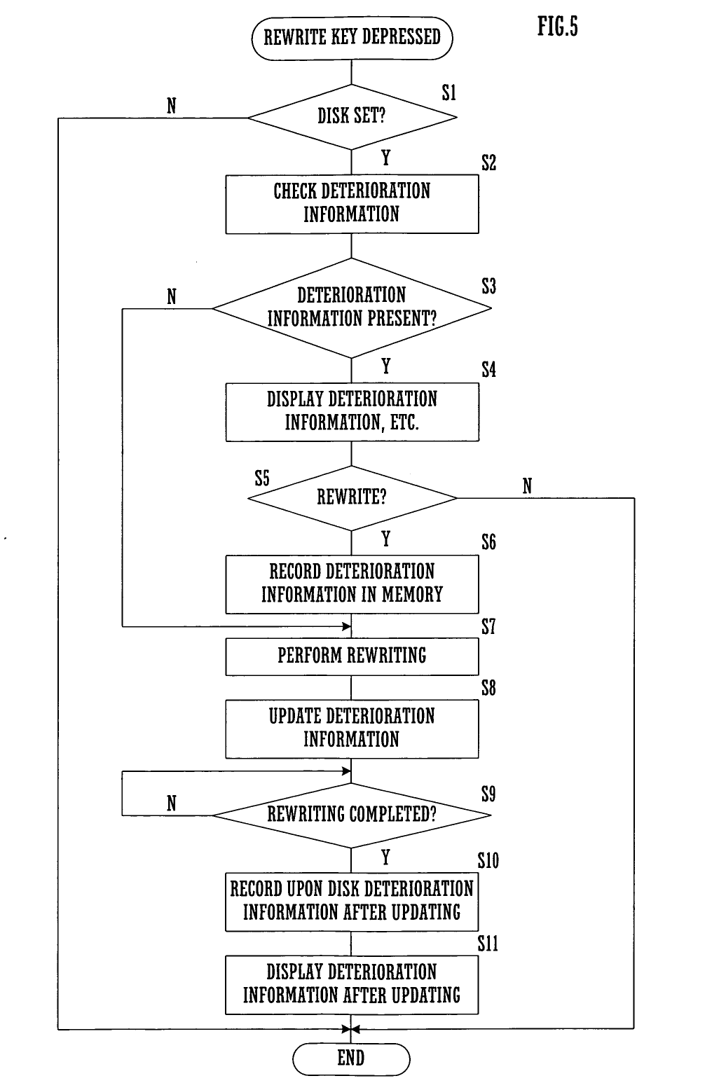

The OSD processing unit 12 creates the OSD image using data for OSD which is stored in the storage unit 6. This OSD image is an image which is based upon notification information to be OSD displayed upon the television 101, as described hereinafter with reference to FIG. 5 and steps S4 or S11. This notification information consists of characters specifying deterioration information read from the optical disk 100, deterioration information after updating, or whether or not rewriting has been performed successfully.

The image processing unit 13 converts the video data, the OSD video data, or the synthetic video data which has been inputted to an analog replay video signal, which it outputs to the external television 101.

The television 101 is connected to the D/A converter 11 and the image processing unit 13. Upon this television 101, the user is able to view an image based upon the video signals which are outputted from the D/A converter 11 and the image processing unit 13, and audio based upon the audio signal.

Next, the operation during recording will be explained.

The reception unit 10 is, for example, a tuner. The reception unit 10 extracts a TV broadcast signal of a selected channel from an antenna which receives TV broadcasts or the like, A/D converts this signal, digitalizes it, and outputs it.

And the recording and replay unit 3 encodes data which has been inputted (for example by MPEG), and outputs a digital signal to the PU head 2.

And, upon input of this digital signal from the recording and replay unit 3, the PU head 2 controls laser light of the recording power according to this digital signal, and irradiates it upon the recording surface of the optical disk 100.

It should be understood that the OSD display described above is also performed during recording.

The operation unit 5 is for the user to input various commands to the optical disk device 1, and is provided with a plurality of keys. Commands inputted to the optical disk device 1 by the user are transmitted to the control unit 4.

The plurality of keys include a replay key, an image record key, an initialize key, and a rewrite confirm key which is selection means.

The rewrite confirm key is a key for receiving a selection as to whether or not it is proper to perform rewriting.

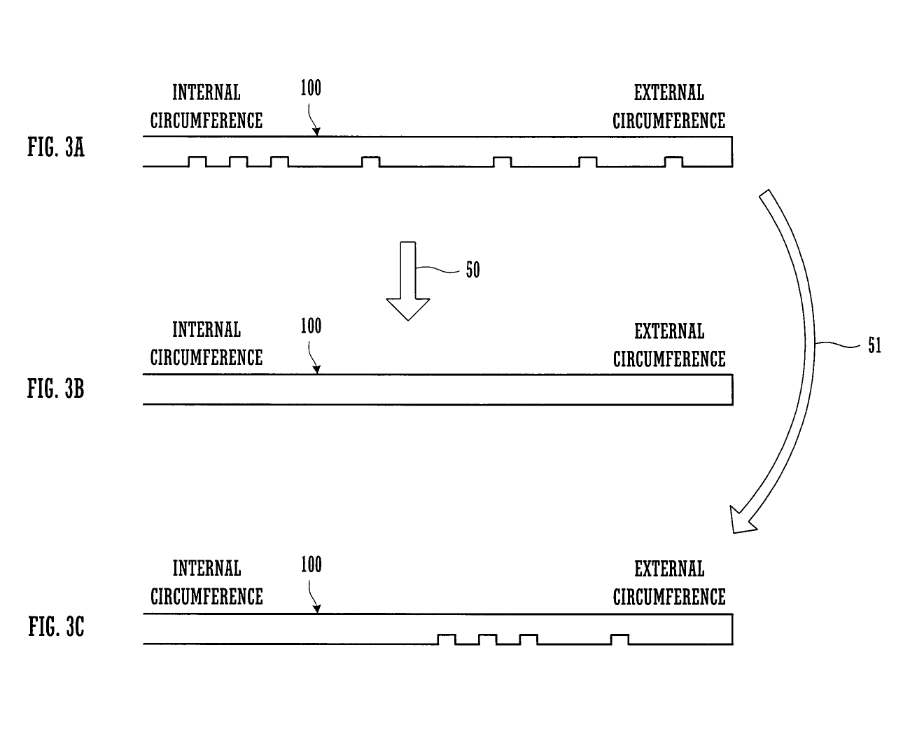

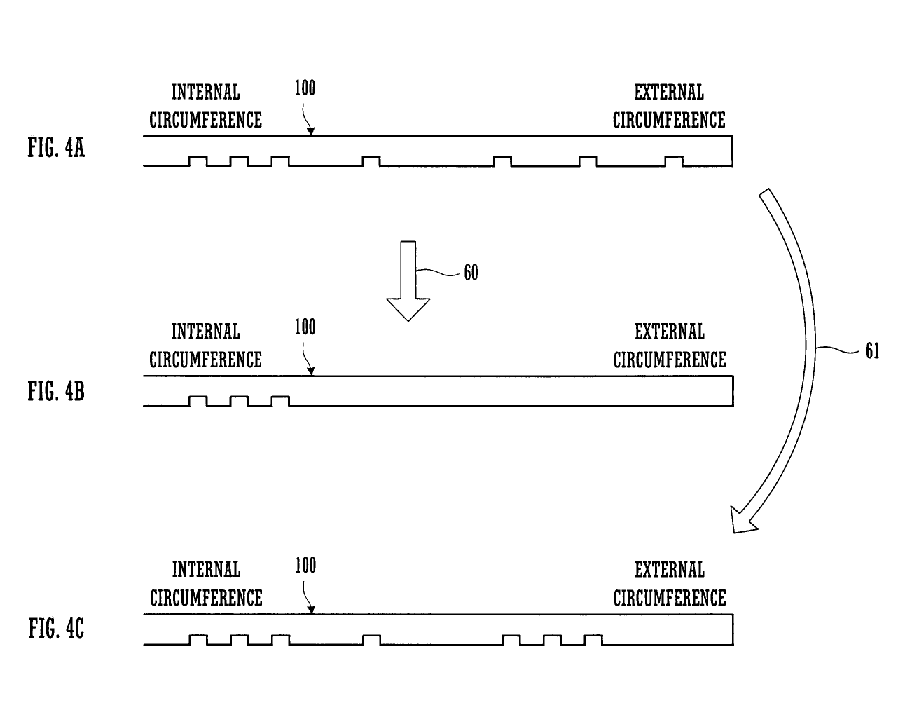

The initialize key may act as a full initialize key which deletes all the data recorded upon the optical disk 100, or as a partial initialize key which deletes only a portion of the data recorded upon the optical disk 100 (as described hereinafter with reference to FIGS. 3 and 4).

Furthermore, by depressing the image record key, the user is able to overwrite data upon an optical disk 100 upon which data is already recorded (as described hereinafter with reference to FIGS. 3 and 4).

Hereinafter, the initialize key and the image record key will be termed “rewrite keys”.

The storage unit 6 may, for example, comprise an EEPROM. This storage unit 6 stores a main control program for the optical disk device 1, and the OSD data which is the basis for the above described notification information.

The display section 7 may, for example, comprise an LCD (Liquid Crystal Display). This display section 7 displays the current time, the setting state of the optical disk device 1, the above described notification information, and the like.

The control unit 4 may comprise, for example, a micro computer. This control unit 4 controls the various sections of the optical disk device 1, according to commands which are inputted to the optical disk device 1 from the user.

It should be understood that, in an actual optical disk device, during reading and during recording, tracking servo control to keep the irradiation position of the laser light in the center of the track upon the optical disk and focus servo control to keep the focal position of the laser light upon the recording surface of the optical disk are performed. However, in the embodiment of the present invention shown in the figures, these matters are not shown.

Here, the display section 7 and the television 101 correspond to the “display means” of the Claims. Moreover, the PU head 2 and the recording and replay unit 3 correspond to the “rewriting and reading means” of the Claims. And the OSD processing unit 12 and the control unit 4 correspond to the “control means” of the Claims.

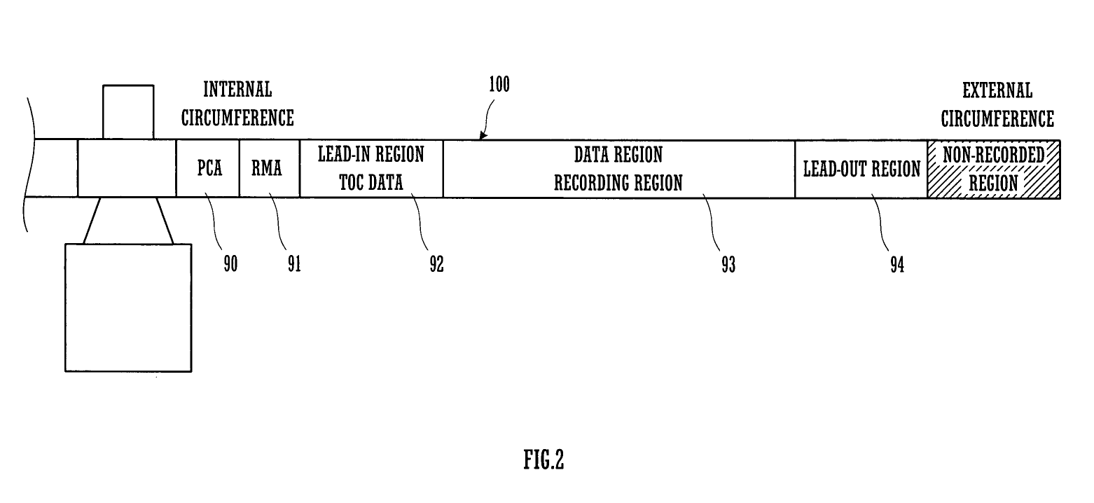

FIG. 2 is a figure showing the recorded region upon the optical disk 100. This recorded region upon the optical disk 100 is divided, from the internal circumference thereof towards its outer circumference, into a PCA 90, a RMA 91, a lead-in region 92, a data region 93, and a lead-out region 94.

The PCA 90 is a region in which proofing of the laser power is performed. The laser power has three levels: a recording power, a reading power, and a deletion power.

The RMA 91 is a region in which record management information which is necessary for the optical disk device 1 is recorded.

The lead-in region 92 is a region in which TOC data for the data which is recorded in the data region 93 upon the optical disk 100 is recorded. In this TOC data, there is included information as to whether or not data which has been stored is finalized, the data that the data was stored, title information for the stored data, and address information of the stored data upon the optical disk or the like.

The data region 93 is a region in which the stored data is recorded.

The lead-out region 94 is a region in which the data which has been stored is created when it is finalized. This finalization is a process for putting the recorded information into order, in order for it to be interchangeable with other optical disk devices. By performing this finalization, it becomes possible also to replay this optical disk 100 upon another optical disk device.

In the following, the definition of rewriting will be explained.

Rewriting of data basically consists of overwriting recording of data, but also includes deletion of data. Due to such rewriting, the data recording surface of the optical disk 100 changes as shown in FIGS. 3A through 3C or as shown in FIGS. 4A through 4C.

FIGS. 3A through 3C are conceptual figures showing a situation in which all of the data which is recorded upon the optical disk 100 is rewritten. FIG. 3A is a conceptual figure showing the state of the data recording surface which is recorded upon the optical disk 100 before rewriting. FIG. 3B is a conceptual figure showing the state of the data recording surface which is recorded upon the optical disk 100 after initialization. And FIG. 3C is a conceptual figure showing the state of the data recording surface which is recorded upon the optical disk 100 after overwriting.

When full initialization is performed by depressing the full initialize key, the data recording surface of the optical disk 100 changes from the state shown in FIG. 3A to the state shown in FIG. 3B (refer to the arrow sign 50), and appears the same as that of a new disk.

On the other hand, when all of the data upon the optical disk 100 is overwritten by the image record key being depressed, the data recording surface of the optical disk 100 changes from the state shown in FIG. 3A to the state shown in FIG. 3C (refer to the arrow sign 51).

FIGS. 4A through 4C are conceptual figures showing a situation in which only a portion of the data which is recorded upon the optical disk 100 is rewritten. FIG. 4A is a conceptual figure showing the state of the data recording surface which is recorded upon the optical disk 100 before rewriting. FIG. 4B is a conceptual figure showing the state of the data recording surface which is recorded upon the optical disk 100 after a portion thereof has been initialized. And FIG. 4C is a conceptual figure showing the state of the data recording surface which is recorded upon the optical disk 100 after a portion thereof has been overwritten.

When partial initialization is performed by depressing the partial initialize key, the data recording surface of the optical disk 100 changes from the state shown in FIG. 4A to the state shown in FIG. 4B (refer to the arrow sign 60).

On the other hand, when a portion of the data upon the optical disk 100 is overwritten by the image record key being depressed, the data recording surface of the optical disk 100 changes from the state shown in FIG. 4A to the state shown in FIG. 4C (refer to the arrow sign 61).

FIG. 5 is a flow chart showing the operation performed by the control unit when the rewrite key upon this optical disk device which is an embodiment of the present invention is depressed. When, for example, the user sets an optical disk 100 into the optical disk device 1, the optical disk device 1 displays a list of the files which are recorded upon the optical disk 100 upon the display section 7 or the television 101. And the user looks at the display section 7 or the television 101, and commands rewriting of some data using the rewrite key of the actuation unit 5.

When the rewrite key is thus depressed, the control unit 4 checks with the PU head 2 to ensure that an optical disk 100 is indeed set in the optical disk device 1 (a step S1).

If it is decided that no optical disk 100 is set in the optical disk device 1, then the control unit 4 terminates this processing.

On the other hand, if it is decided that an optical disk 100 is indeed set in the optical disk device 1, then the control unit 4 commands the PU head 2 to read the lead-in region 92 upon the optical disk 100 (a step S2), and checks the deterioration information. This deterioration information is information which indicates the extent of progression of deterioration of the optical disk 100. Such deterioration information may be, for example, the number of times the disk has been rewritten, or the remaining number of times that it can be rewritten. The relationship between the number of times that the disk has been rewritten and the remaining number of times that the disk can be rewritten is that “the number of times that the disk has been rewritten+the remaining number of times that the disk can be rewritten=the maximum limit number of times that the disk can be rewritten”.

The control unit 4 checks the TOC data which it has acquired via the PU head 2 and the recording and replay unit 3, and decides whether or not deterioration information is present in the lead-in region 92 of the optical disk 100 (a step S3). If the result of this decision in the step S3 is negative, then the case is assumed that the optical disk 100 has not been rewritten even once, and that only recording has been performed thereupon.

If it is decided that no deterioration information is present in the lead-in region 92, then the flow of control proceeds to the step S7, and processing is continued.

On the other hand, if it is decided that deterioration information is present in the lead-in region 92, then the control unit 4 commands the OSD processing unit 12 to display characters showing whether or not it is acceptable to perform rewriting of the optical disk 100, and the deterioration information which has been thus read out (a step S4). Or, the control unit 4 may display characters on the display section 7, showing whether or not it is acceptable to perform rewriting of the optical disk 100, and the deterioration information which has been read out (the step S4).

As a result, the OSD processing unit 12 may synthesize as a video signal, based upon the deterioration information which has been read out, characters which indicate the extent of progression of deterioration, and whether or not it is acceptable to perform rewriting, and may display these characters upon the television 101. On the other hand, the display section 7 may display, based upon the deterioration information which has been read out, characters which indicate the extent of progression of deterioration, and whether or not it is acceptable to perform rewriting.

These displays may be, for example, “At present, the number of times that the disk has been rewritten is 950. Rewrite?” or “At present, the remaining number of times that the disk can been rewritten is 50. Rewrite?”.

In summary, the control unit 4 decides whether or not a selection has been made with the rewrite confirm key to the effect that rewriting should be performed (a step S5). In this step, the system waits for a selection as to whether or not rewriting of the optical disk 100 should be performed.

Furthermore, in the steps S4 and S5, by the rewrite confirm key being selected after the extent of progression of the deterioration has been displayed based upon the deterioration information before performing the rewriting, it is arranged for the rewriting to be performed after the user has been informed of the extent of progression of the deterioration.

By doing this, for example, it becomes possible for the user to decide to abandon rewriting this time, if the disk can only be rewritten a few times more.

If selection has been made with the rewrite confirm key to the effect that rewriting should not be performed, then the control unit 4 terminates this processing.

On the other hand, if selection has been made with the rewrite confirm key to the effect that rewriting should be performed, then the control unit 4 records the deterioration information which has been read out in the storage unit 6 (a step S6).

And the control unit 4 commands the various sections of the optical disk device 1 to execute operations for performing rewriting of the optical disk 100 (a step S7). In other words, the control unit 4 starts control for performing the rewriting. As a result, after proofing of the laser power has been performed upon the PCA of the optical disk 100, the PU head 2 starts rewriting the data.

While the various sections of the optical disk device 1 are performing the rewriting, the control unit 4 updates the deterioration information in the storage unit 6 to the newest information (a step S8). To explain this in detail: the control unit 4 may, for example, add “1” to the number of times that the disk has been rewritten, or may subtract “1” from the remaining number of times that the disk can be rewritten. In the case of an optical disk for which the result of the decision in the step S3 was negative, the control unit may create, as the deterioration information after updating, that the number of times the disk has been rewritten is “1”, or that the current remaining number of times that the disk can be rewritten is [the maximum limit number of times the disk can be rewritten—the number of times that the disk has been rewritten (i.e. “1”)].

The control unit 4 waits until the rewriting of the optical disk 100 has been completed (a step S9), and then commands the PU head 2 to update the deterioration information of the optical disk 100 to the newest information (a step S10). To explain this in detail: the control unit 4 reads out the deterioration information after updating from the storage unit 6 and transmits it to the to the recording and replay unit 3, and, using the PU head 2, overwrite records the deterioration information upon the optical disk 100 so as to change it to the deterioration information after updating. As the deterioration information after updating, for example, this may be the number of times that the disk has been rewritten, incremented by “1”, or may be the number of remaining times that the disk can be rewritten, decremented by “1”.

Then, the control unit 4 commands the OSD processing unit 12 to display the extent of progression of the deterioration, based upon the deterioration information after updating (a step S11). Or, the control unit 4 displays the extent of progression of the deterioration upon the display section 7, based upon the deterioration information after updating (the step S11). In either case, this processing is then terminated.

These displays may be, for example, “The number of times that the disk has now been rewritten has become 950” or “The number of remaining times that the disk can now be rewritten has become 50”.

In this manner, each time a command is issued for rewriting the optical disk 100, the optical disk device 1 repeats the flow of reading out the deterioration information, updating it, and rewriting it.

And, by displaying the extent of progression of the deterioration upon the television 101 or the display section 7 in the steps S4 and S11 based upon the deterioration information, the optical disk device 1 notifies the user of the number of times that this optical disk 100 has been rewritten, or of the exchange timing for this optical disk 100, or the like.

By the above, the user is able to ascertain the number of times that this optical disk 100 has been rewritten, or the exchange timing for this optical disk 100, or the like.

Furthermore, by the remaining number of times that this disk can be rewritten being displayed based upon the deterioration information, the user is able to ascertain how many times he will be able subsequently to rewrite the data upon the optical disk 100.

It should be understood that although, in this embodiment, the extent of progression of the deterioration is displayed based upon the deterioration information before and after rewriting, in an implementation, this information may be displayed at any desired time.

What is claimed is:

1. An optical disk device, comprising:
a rewriting and reading means, comprising a pickup head which irradiates laser light upon a rewritable type optical disk, which rewrites data to or reads data from the rewritable type optical disk;
a control means which controls rewriting and reading of data by the rewriting and reading means, and which moreover, when a command is issued to rewrite data upon the rewritable type optical disk, acquires, via the rewriting and reading means, from a region upon the rewritable type optical disk which is determined in advance, deterioration information which specifies the extent of progression of deterioration of the rewritable type optical disk; and
a display means which displays the extent of progression of the deterioration, based upon the deterioration information which has been acquired by the control means.

2. An optical disk device as described in claim 1,
wherein the display means displays the extent of progression of the deterioration, based upon the deterioration information which has been acquired, before the rewriting of the rewritable optical disk is performed by the rewriting and reading means.

3. An optical disk device as described in claim 2, further comprising a selection means which receives a selection of whether or not to perform the rewriting, in the state in which the extent of progression of deterioration is being displayed upon the display means based upon the deterioration information which has been acquired,
wherein the control means executes control so that the rewriting and reading means performs the rewriting, or not, according to the selection upon the selection means.

4. An optical disk device as described in claim 1,
wherein the control means commands the rewriting and reading means to update the deterioration information upon the rewritable type optical disk to the newest information, after the rewriting of the rewritable optical disk has been performed by the rewriting and reading means.

5. An optical disk device as described in claim 4,
wherein the display means displays the extent of progression of the deterioration based upon the deterioration information after the updating, after the rewriting of the rewritable optical disk has been performed by the rewriting and reading means.

6. An optical disk device as described in claim 4,
wherein, when a command has been issued to rewrite data upon the rewritable type optical disk, if the deterioration information is not present in the region upon the rewritable optical disk, the control means:
creates the deterioration information; and
after rewriting of the rewritable type optical disk has been performed by the rewriting and reading means, commands the rewriting and reading means to record the deterioration information which has been created in the region upon the rewritable optical disk.
